(19) United States
(12) Patent Application Publication
(10) Pub. No.: US 2015/0108108 A1
(43) Pub. Date: Apr. 23, 2015

(54) LIQUID HEATER WITH A MOVABLE BASE ASSEMBLY

(71) Applicant: Ningbo SMAL Electrics Co., LTD., Zhejiang (CN)

(72) Inventors: Yuejun DONG, Zhejiang (CN); Shuaikui HE, Zhejiang (CN)

(73) Assignee: Ningbo SMAL Electrics Co., LTD., Zhejiang (CN)

(21) Appl. No.: 14/260,531

(22) Filed: Apr. 24, 2014

(30) Foreign Application Priority Data
Oct. 22, 2013 (CN) 201320659417.X

(51) Int. Cl. A47J 27/21

(52) U.S. Cl. CPC A47J 27/2105; A47J 27/21041
USPC 219/432; 219/433

(57) ABSTRACT

The disclosure discloses a liquid heater with a movable base assembly, comprising a body portion and a chassis portion. The chassis portion has the movable base assembly which is overlapped with the chassis portion and can be protruded out of the chassis portion. The liquid heater with the movable base assembly according to the disclosure has the receiving function, wherein the movable base assembly can be received on the chassis portion. Thereby, the liquid heater with the movable base assembly of the application has the advantages of a compacted structure, having the receiving function, convenient use and great utility.

This application claims priority to Chinese Patent Application No. 201320659417.X filed on Oct. 22, 2013, the content of which is hereby incorporated by reference.

### TECHNICAL FIELD

The disclosure relates to an electrical appliance, and particularly to a liquid heater with a movable base assembly.

### BACKGROUND ART

Electrical appliances, such as electric kettle, egg cooker, milk boiler and coffee machine, for heating such liquid as water, milk and coffee are collectively called as a liquid heater because of its function for heating liquid.

The liquid heater may be divided into an integrated-type liquid heater in which its body portion and the chassis portion are formed as one integrated piece, and a separated-type liquid heater in which its body portion and the chassis portion are formed as separated portions. Generally, the separated-type liquid heater is easier for a user to use. Wherein, the liquid to be heated is filled into a cavity of the body portion, and a heating element is provided on the bottom portion of the body portion to heat the liquid.

For an electric kettle, the user generally makes tea by using the body portion. And the body portion is provided with a tea basket. After drinking up the tea, the user needs to get the tea basket out of the body portion and add more water for heating. However, the conventional electric kettle has no corresponding design to put the tea basket, so that it is not convenient for user to use.

Likewise, during the heating of the liquid heater with pressure, it is usually required to place a water cup, tea or other small items associated with heating liquid. However, the existing liquid heater with the movable base assembly does not have the performance for conceiving or carrying the small items mentioned above, and thereby does not meet the user's actual needs so as to bring inconvenience for the user's use.

As above described, the existing liquid heater has the shortcomings of no performance for receiving the small items and inconvenient using.

### SUMMARY OF THE DISCLOSURE

To overcome the problems existed in the prior art, an object of the disclosure is to provide a liquid heater with a movable base assembly to solve the technical problem, i.e. the existing liquid heater does not have a performance of receiving small items and is used inconveniently.

The disclosure is achieved by the following technical solutions.

A liquid heater with a movable base assembly, wherein the liquid heater comprises a body portion and a chassis portion, the chassis portion has the movable base assembly which can be received in the chassis portion and integrated with it, or can be protruded out of the chassis portion.

Preferably, the liquid heater with the movable base assembly of the disclosure is a separated-type liquid heater.

Preferably, the movable base assembly includes a chassis portion body portion provided on the bottom of the chassis portion and a hinged shaft provided on one side of the chassis portion body portion and perpendicular to the chassis portion body portion, the top end of the hinged shaft being connected to the chassis portion body portion.

Preferably, the movable base assembly has a receiving part which is a round hole or a recess.

Preferably, the liquid heater further comprises a storage tray which is disposed on the receiving part.

Preferably, the body portion has a receiving space for receiving the heated liquid and a heating assembly for heating liquid, the heating assembly inwardly protrudes to the receiving space from the bottom of the receiving space, and the heating assembly has a cover body portion and a heating tube provided on the inner wall of the cover body portion.

Preferably, the body portion is also provided with a tea basket which stretches into the receiving space and is held at a mouth of the body portion.

Preferably, the movable base assembly is a drawer-type base assembly.

Preferably, the drawer-type base assembly can be drawn in a horizontal direction to open, and in a direction from the body portion to the key area or perpendicular to the direction from the body portion to the key area.

Preferably, the liquid heater with the movable base assembly is an electric kettle, an egg maker or a coffee machine.

In conclusion, the disclosure has advantages in that the liquid heater with the movable base assembly has a drawer-type or rotable base assembly having a receiving performance such that a user can receive or carry the small items, such as a water cup, a tea pocket, a tea caddy and/or a tea basket, and the movable base assembly is also superposed on the chassis portion. Thereby, the liquid heater according to the disclosure has a compacted structure, a receiving performance, convenient use and great utility.

### BRIEF DESCRIPTION OF THE DRAWINGS

FIG. 1 is a top view of the movable base assembly as being received in the chassis portion according to the first embodiment of the disclosure.

FIG. 2 is a top view of the movable base assembly as being protruded from the chassis portion according to the first embodiment of the disclosure.

FIG. 3 is a schematic cross-sectional view of the movable base assembly as being protruded from the chassis portion according to the first embodiment of the disclosure.

FIG. 4 is a schematic cross-sectional view of the movable base assembly as being received in the chassis portion according to the first embodiment of the disclosure.

FIG. 5 is a fop view of the movable base assembly as being protruded from the chassis portion according to the second embodiment of the disclosure.

FIG. 6 is a perspective view of the movable base assembly as being received in the chassis portion according to the second embodiment of the disclosure.

FIG. 7 is a schematic cross-sectional view of the movable base assembly as being received in the chassis portion according to the second embodiment of the disclosure.

### DETAILED DESCRIPTION OF THE PREFERRED EMBODIMENTS

The preferred embodiments reflecting features and advantages of the disclosure will be described in details. It should be understood that variations of the different embodiments of the disclosure all do not depart from the scope sought for protection, and the illustration and drawings substantially serve for explanation rather than limit the disclosure.

The liquid heater according to the embodiments of the disclosure may be an integrated-type liquid heater or a separated-type liquid heater, may be but not limited to an electric kettle, an egg maker, and a coffee machine, etc.

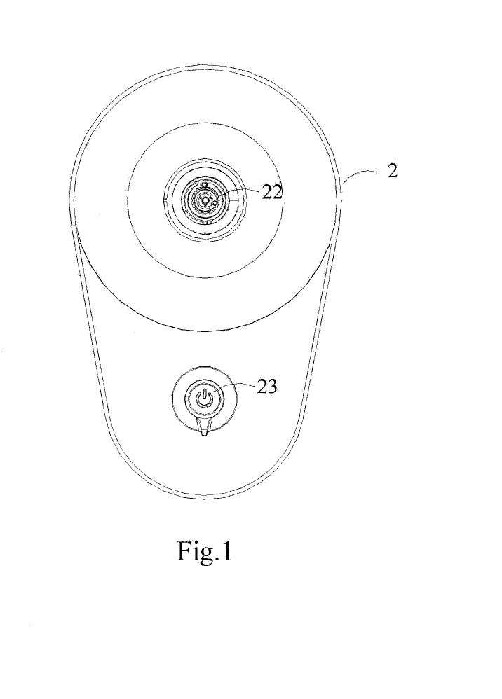

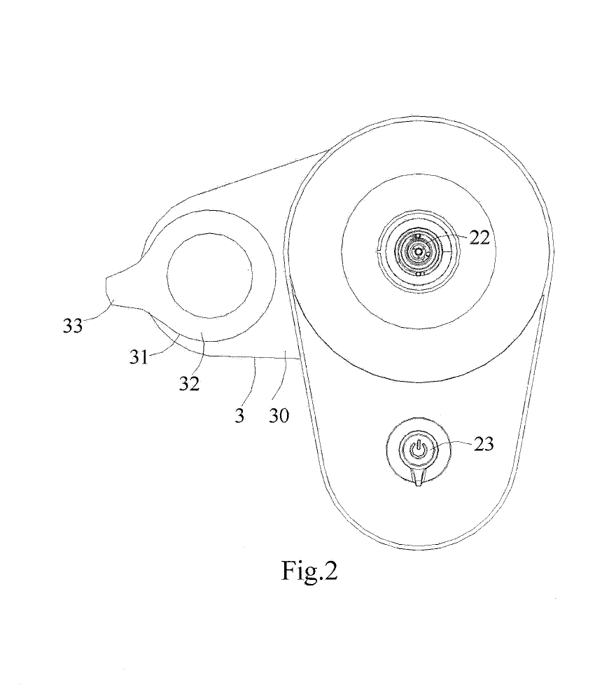

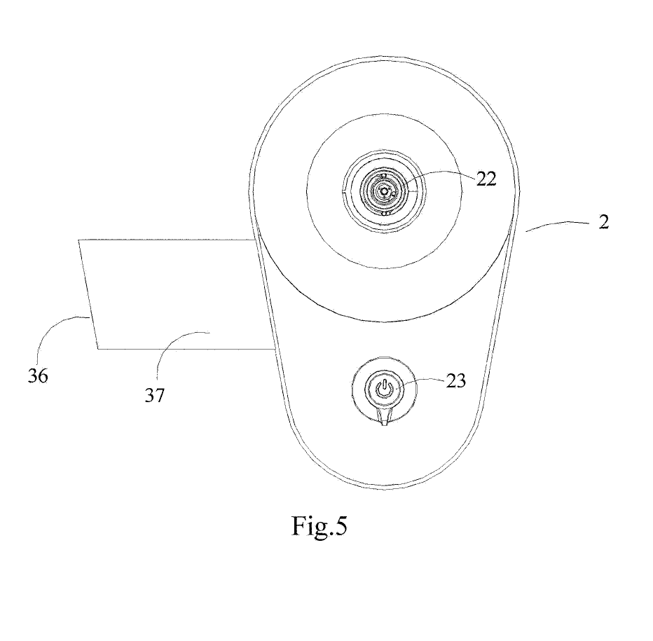

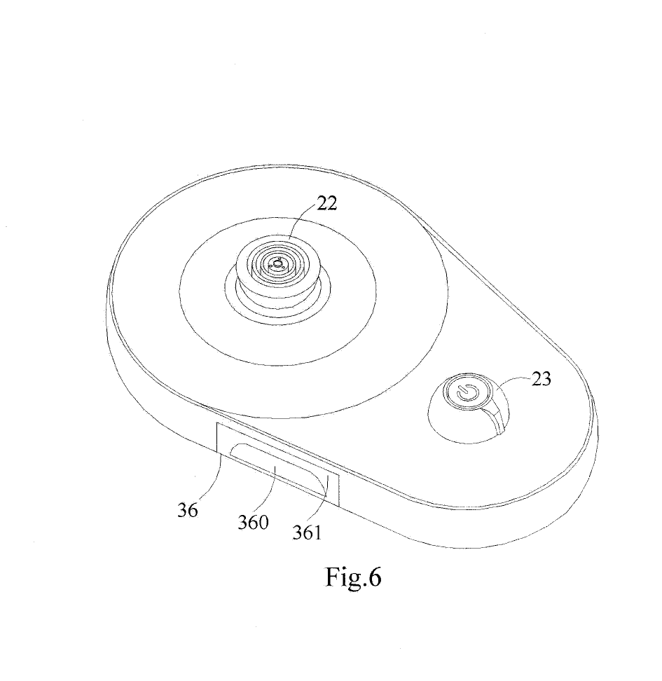

As shown in FIG. 1 and FIG. 2, the liquid heater with a movable base assembly according to the embodiments of the disclosure comprises a body portion (not shown), a chassis portion 2 and a movable base assembly 3 provided on the chassis portion 2. The body portion and the chassis portion 2 can be separated, that is, the body portion and the chassis portion may be connected with each other to heat the liquid and separated to fill the liquid into the body portion and use the heated liquid. For example the body portion can be used as a teapot. The movable base assembly 3 is provided on the bottom of the chassis portion 2, may be received under the chassis portion 2 and integrated with the chassis portion 2, or protruded out of the chassis portion 2 in a horizontal direction.

Wherein, the body portion comprises a receiving space, a handle, a kettle cover, a heating assembly and an upper connector. As shown in FIG. 1, FIG. 2, FIG. 5 and FIG. 6, a lower connector 22 on the chassis portion 2 is connected to the upper connector on the body portion to supply power for the heating element of the body portion.

Wherein, the receiving space is used to receive heated liquid, such as water and milk, etc. a tea basket used to contain tea is provided in the receiving space and held at a mouth of the body portion. The disclosure is not limited to this, i.e. the liquid heater of the present disclosure can be not provided with the tea basket.

The body portion has a heating assembly for heating liquid which may protrude toward the receiving space from the bottom thereof. The heating assembly may include a cover body portion and a heating tube provided on the inner wall of the cover body portion. The heating tube, for example, is spiral and can heat the liquid contained in the receiving space.

As shown in FIG. 1 and FIG. 2, the chassis portion 2 includes a key area 23. The key area is a user interface to provide function selection for a user.

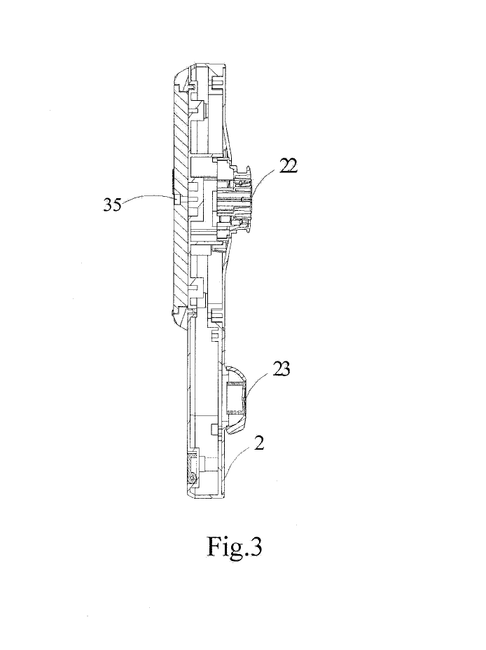

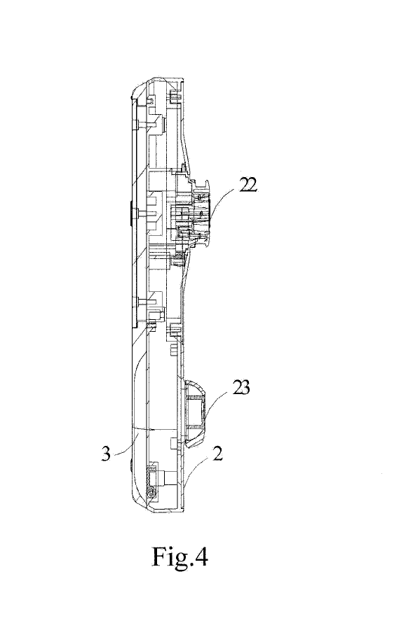

A liquid heater with a movable base assembly 3 according to the first embodiment of the disclosure is shown in FIG. 1 to FIG. 4, wherein, the movable base assembly 3 comprises a chassis portion body portion 30, a hinged shaft (rotating shaft) 35 and a receiving part 31 provided on the base assembly 3. The hinged shaft 35 is provided on one side of the chassis portion body portion 30 and perpendicular to the chassis portion body portion 30. The chassis portion body portion 30 is fixedly connected to the hinged shaft 35, and the top end of the hinged shaft 35 is pivotably connected to the chassis portion body portion 30. The receiving part 31 is formed of a recess, but the disclosure is not limited to this, a round hole is provided on the chassis portion body portion and constitutes the receiving part 31. And also, the movable base assembly 3 of the disclosure may not include the recess or the round hole, but the chassis portion body portion 30 of the movable base assembly 3 directly forms the receiving part 31. The receiving part 31 has receiving function, for example, the tea basket can be put onto the receiving part 31 when it is required to take the tea basket out of the body portion, and also, the receiving part 31 is used to contain the water cup and tea.

As shown in FIG. 2, in the liquid heater with a movable base assembly according to the first embodiment of the disclosure, the movable base assembly 3 further comprises a storage tray 32 which has a size and a shape in match with that of the receiving part 31 and can be separately and movably provided above the receiving part 31. And also, the storage tray 32 has a handle 33 on its ends to facilitate for holding. The storage tray 32 of the disclosure is easy to be assembled and disassembled in addition to have the receiving function. The disclosure is not limited to this, i.e. may not provided with a removable storage tray 32 but achieve the receiving function directly through the receiving part 31.

The liquid heater with the movable base assembly according to the first embodiment of the disclosure is also provided with a locking member on the bottom of the chassis portion, for locking the movable base assembly 3 when the movable base assembly 3 is received in the chassis portion. Generally, the movable base assembly 3 is received in the chassis portion 2, and integrated with the chassis portion 2; when the movable base assembly 3 is rotated out of the chassis portion 2, the receiving part 31 is exposed outside the chassis portion 2 to achieve the receiving function to receive some small items associated with heating liquid. The receiving part 31 may rotate around the hinged shaft 35 as a rotation shaft to different direction along a horizontal plane.

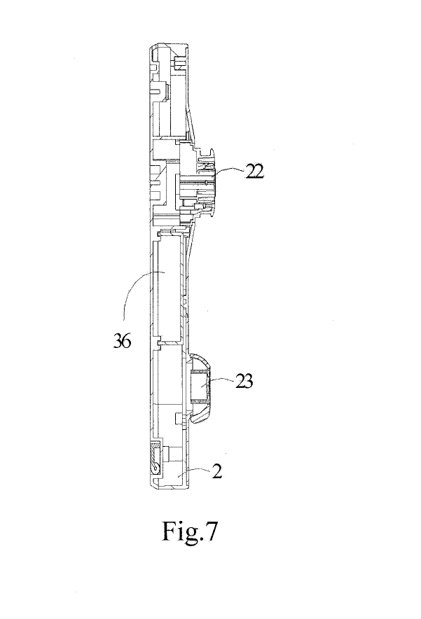

As shown in FIG. 5 to FIG. 7, the liquid heater with the movable base assembly according to the second embodiment of the disclosure is substantially the same as that according to the first embodiment of the disclosure, the same description are not repeated herein. The difference lies in that the liquid heater with the movable base assembly according to the second embodiment of the disclosure has the movable base assembly 3 which is drawer-type base assembly. The drawer-type base assembly can be drawn horizontally to open, the direction of drawing the drawer-type base assembly is perpendicular to the direction from the body portion to the key area 23, but the disclosure is not limited to this, the direction of drawing can be along the direction from the body portion to the key area. The drawer-type base assembly 36 may be in an inverted U shape and includes a chassis portion panel 361 having a groove 360 and a chassis portion body portion 37, the chassis portion body portion 37 forms the receiving part of the drawer-type base assembly, and the user can draw out and push in the base assembly by the groove 360 of the chassis portion panel 361. The receiving part has function and structure substantially identical to the receiving part of the liquid heater with the movable base assembly according to the first embodiment of the disclosure, and thusly the repeated description will not provide here.

In conclusion, the liquid heater with the movable base assembly according to the disclosure has a drawer-type or rotatable movable base assembly 3 with a receiving function, so that the user can put the water cup, tea and/or the tea basket or some small items associated with heating liquid in the movable base assembly 3, and the movable base assembly 3 is also superposed on the chassis portion. Thereby, the liquid heater has follow advantages of a compacted structure, receiving function, convenient use and great utility.

Although the technical solution of the disclosure has been described as above in reference to several preferred embodiments, it would be understood for those skilled in the art that that modifications or variations without departing from the spirit or principle of the disclosure as claimed by the appended claims fall within the protection scope defined by the claims of the disclosure.

What is claimed is:

1. A liquid heater with a movable base assembly, wherein the liquid heater comprises a body portion and a chassis portion, the chassis portion has the movable base assembly which can be received in the chassis portion and integrated with it, or can be protruded out of the chassis portion.

2. The liquid heater with the movable base assembly according to claim 1, wherein the liquid heater is a separated-type liquid heater.

3. The liquid heater with the movable base assembly according to claim 2, wherein the movable base assembly includes a chassis portion body portion provided on the bottom of the chassis portion and a hinged shaft provided on one side of the chassis portion body portion and perpendicular to the chassis portion body portion, the top end of the hinged shaft being connected to the chassis portion body portion.

4. The liquid heater with the movable base assembly according to claim 3, wherein the movable base assembly has a receiving part which is a round hole or a recess.

5. The liquid heater with the movable base assembly according to claim 4, wherein the liquid heater further comprises a storage tray which is disposed on the receiving part.

6. The liquid heater with the movable base assembly according to claim 1, wherein the body portion has a receiving space for receiving the heated liquid and a heating assembly for heating liquid, the heating assembly inwardly protrudes to the receiving space from the bottom of the receiving space, and the heating assembly has a cover body portion and a heating tube provided on the inner wall of the cover body portion.

7. The liquid heater with the movable base assembly according to claim 1, wherein the body portion is also provided with a tea basket which stretches into the receiving space and is held at a mouth of the body portion.

8. The liquid heater with the movable base assembly according to claim 2, wherein the movable base assembly is a drawer-type base assembly.

9. The liquid heater with the movable base assembly according to claim 8, wherein the drawer-type base assembly can be drawn in a horizontal direction to open, and in a direction from the body portion to the key area or perpendicular to the direction from the body portion to the key area.

10. The liquid heater with the movable base assembly according to claim 9, wherein the liquid heater with the movable base assembly is an electric kettle, an egg maker or a coffee machine.
